(19) United States
(12) Patent Application Publication
(10) Pub. No.: US 2018/0205519 A1
(43) Pub. Date: Jul. 19, 2018

(54) SHORT MULTI-USER NULL DATA PACKET (NDP) FEEDBACK

(71) Applicant: QUALCOMM Incorporated, San Diego, CA (US)

(72) Inventors: Sameer VERMANI, San Diego, CA (US); Bin TIAN, San Diego, CA (US); Lin YANG, San Diego, CA (US)

(21) Appl. No.: 15/872,609

(22) Filed: Jan. 16, 2018

Related U.S. Application Data
(60) Provisional application No. 62/468,848, filed on Mar. 8, 2017.
(60) Provisional application No. 62/447,413, filed on Jan. 17, 2017.

(51) Int. Cl. H04L 5/00

(52) U.S. Cl. CPC H04L 5/0053; H04L 69/323

(57) ABSTRACT

Aspects of the present disclosure provide techniques for receiving and detecting short multi-user feedback in null data packets (NDPs). An example method generally includes receiving a first packet from a first wireless device, the first packet transmitted using resources spanning at least 106 tones and allocated to the first wireless device for conveying feedback bits, and detecting the feedback bits based on a difference in receive energy on different sets of tones.

### CROSS-REFERENCE TO RELATED APPLICATIONS

This application claims benefit of U.S. Provisional Patent Application Ser. No. 62/447,413, filed Jan. 17, 2017 and entitled “Short Multi-User Null Data Packet (NDP) Feedback,” and U.S. Provisional Patent Application Ser. No. 62/468,848, filed Mar. 8, 2017 and entitled “Short Multi-User Null Data Packet Feedback,” both of which are assigned to the assignee hereof, and the contents of both of which are herein incorporated by reference in their entirety.

### BACKGROUND

### Field of the Disclosure

Certain aspects of the present disclosure generally relate to wireless communications and, more particularly, to null data packet feedback in wireless communication systems.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than wireless ranges associated with frequency ranges of other IEEE 802.11 technologies and potentially fewer issues associated with path losses due to obstructions.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure provide a method for wireless communications. The method generally includes receiving a first packet from a first wireless device, the first packet transmitted using resources spanning at least 106 tones and allocated to the first wireless device for conveying feedback bits, and detecting the feedback bits based on a difference in receive energy on different sets of tones.

Aspects of the present disclosure provide a system for wireless communications. The system generally includes a memory and a processor configured to receive a first packet from a first wireless device, the first packet transmitted using resources spanning at least 106 tones and allocated to the first wireless device for conveying feedback bits, and detect the feedback bits based on a difference in receive energy on different sets of tones.

Aspects of the present disclosure provide a system for wireless communications. The system generally includes means for receiving a first packet from a first wireless device, the first packet transmitted using resources spanning at least 106 tones and allocated to the first wireless device for conveying feedback bits, and means for detecting the feedback bits based on a difference in receive energy on different sets of tones.

Aspects of the present disclosure provide a computer-readable medium for wireless communications. The computer-readable medium generally includes instructions stored thereon which, when executed by one or more processors, receives a first packet from a first wireless device, the first packet transmitted using resources spanning at least 106 tones and allocated to the first wireless device for conveying feedback bits, and detects the feedback bits based on a difference in receive energy on different sets of tones.

Aspects of the present disclosure provide a method for wireless communications. The method generally includes receiving, from a first wireless device, a feedback request, and transmitting, to the first wireless device, a first packet transmitted using resources spanning at least 106 tones and allocated for conveying feedback bits from the first wireless device, wherein values of the feedback bits are represented by differences in receive energy on different sets of tones.

Aspects of the present disclosure provide a system for wireless communications. The system generally includes a memory, and a processor configured to receive, from a first wireless device, a feedback request, and transmit, to the first wireless device, a first packet transmitted using resources spanning at least 106 tones and allocated for conveying feedback bits from the first wireless device, wherein values of the feedback bits are represented by differences in receive energy on different sets of tones.

Aspects of the present disclosure provide a system for wireless communications. The system generally includes means for receiving, from a first wireless device, a feedback request, and means for transmitting, to the first wireless device, a first packet transmitted using resources spanning at least 106 tones and allocated for conveying feedback bits from the first wireless device, wherein values of the feedback bits are represented by differences in receive energy on different sets of tones.

Aspects of the present disclosure provide a computer-readable medium for wireless communications. The computer-readable medium generally includes instructions stored thereon which, when executed by a processor, receives, from a first wireless device, a feedback request and transmits, to the first wireless device, a first packet transmitted using resources spanning at least 106 tones and allocated for conveying feedback bits from the first wireless device, wherein values of the feedback bits are represented by differences in receive energy on different sets of tones.

Aspects of the present disclosure also provide various methods, other apparatuses, and computer readable medium capable of performing the operations described above and herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example frame structure with long training fields (LTFs), accordance with certain aspects of the present disclosure.

FIGS. 5A-5C illustrate example divisions of RUs into sets of tones for receiving feedback, in accordance with certain aspects of the present disclosure.

FIG. 6 illustrates a block diagram of example operations for wireless communications by a transmitting apparatus, in accordance with certain aspects of the present disclosure.

FIG. 7 illustrates a block diagram of example operations for wireless communications by a receiving apparatus, in accordance with certain aspects of the present disclosure.

FIG. 8 illustrates an example of tones on which different bit values can be identified, in accordance with certain aspects of the present disclosure.

FIG. 9 illustrates a block diagram of example operations for wireless communications by a transmitting apparatus, in accordance with certain aspects of the present disclosure.

FIG. 10 illustrates a block diagram of example operations for wireless communications by a receiving apparatus, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure generally relate to wireless communications and, more particularly, to techniques that may be used for detecting short feedback from one or more users. The short feedback may be detected based on a difference in receive energy on different sets of tones in a wideband resource unit (RU) (e.g., an RU having at least 106 tones). By detecting short feedback from one or more users based on a difference in receive energy on different sets of tones, an amount of feedback that can be received by a device may be increased relative to feedback received on tones in an RU with a narrower bandwidth (e.g., an RU having 26 tones).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communications System

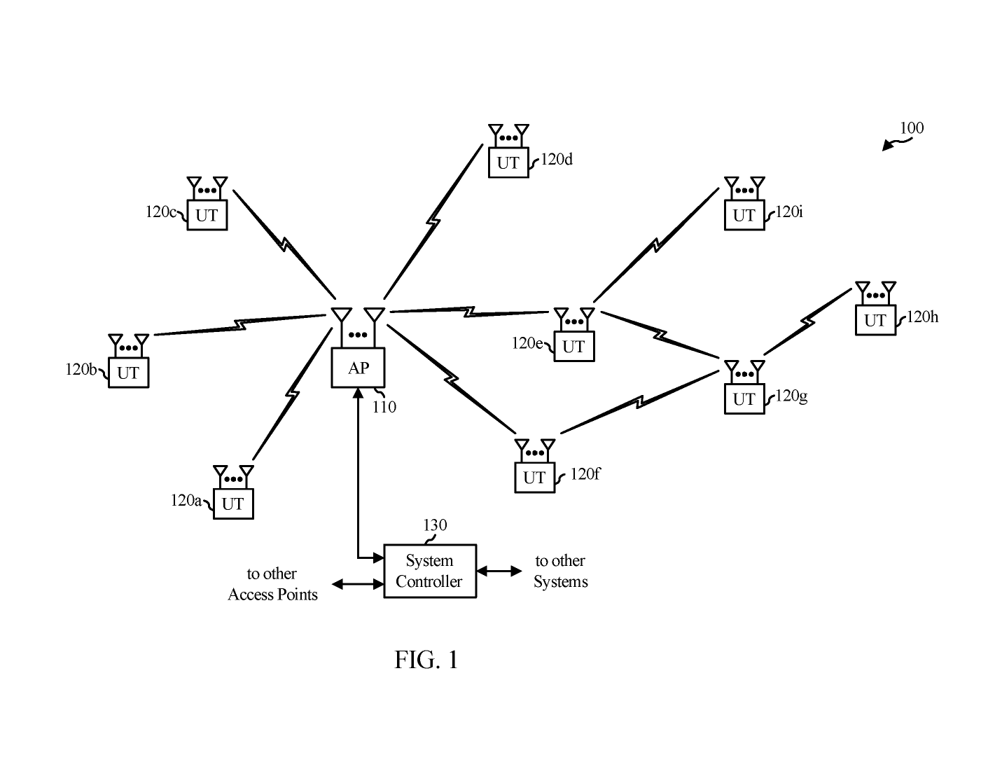

FIG. 1 illustrates a system 100 in which aspects of the disclosure may be performed. For example, any of the wireless stations including the access point 110 and/or the user terminals 120 may be in a neighbor aware network (NAN). Wireless stations may exchange fine timing measurement (FTM) information for ranging during a period when the wireless stations are already scheduled to wake up (e.g., during a paging window or data window) and may exchange the FTM information using existing frames (e.g., association frames, trigger/polling frames, probe request/probe response frames). In aspects, one of the wireless devices may act as a ranging proxy.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

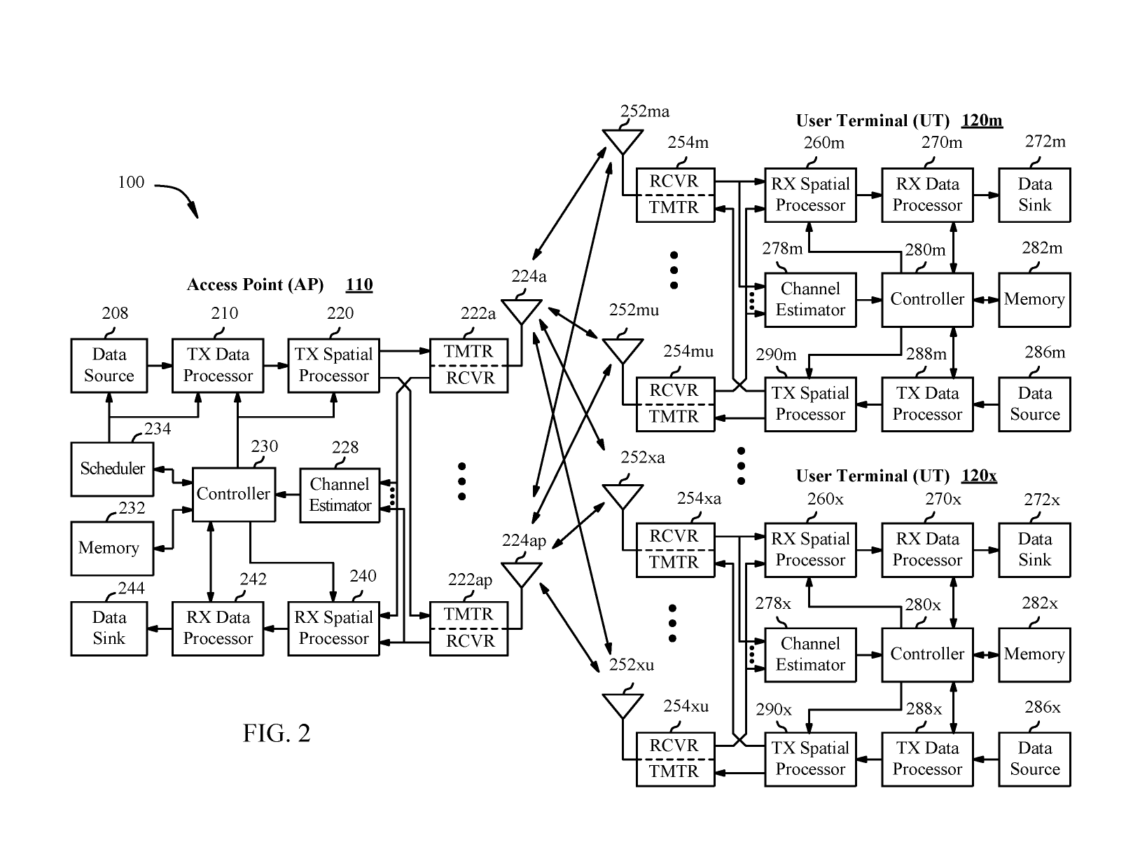

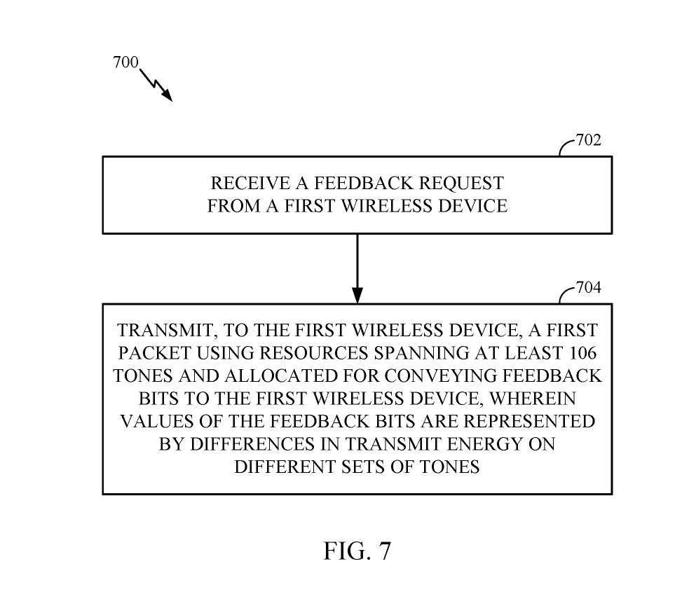

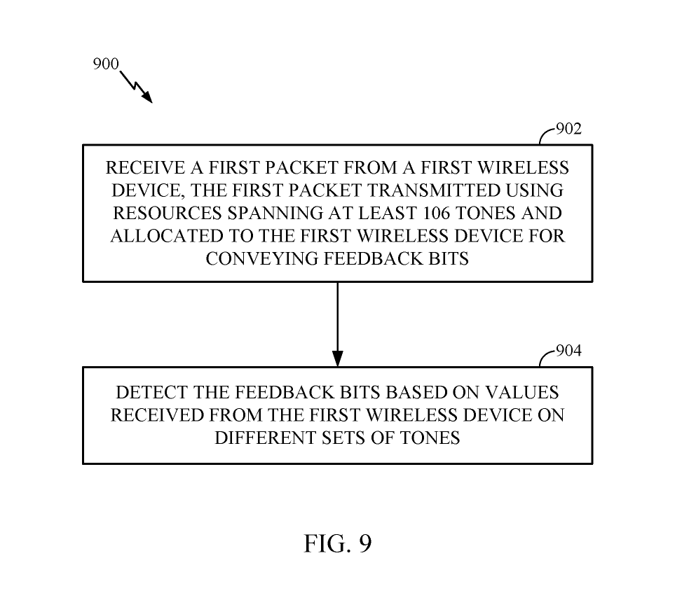

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, and/or processors 210, 220, 240, 242, of the AP 110, and/or controller 230 or antenna 252, Tx/Rx 254, processors 260, 270, 288, and 290, and/or controller 280 of UT 120 may be used to perform the operations 700 and 700A described herein and illustrated with reference to FIGS. 7 and 7A, respectively, and operations 900 and 900A described herein and illustrated with reference to FIGS. 9 and 9A, respectively.

FIG. 2 illustrates a block diagram of access point 110 two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

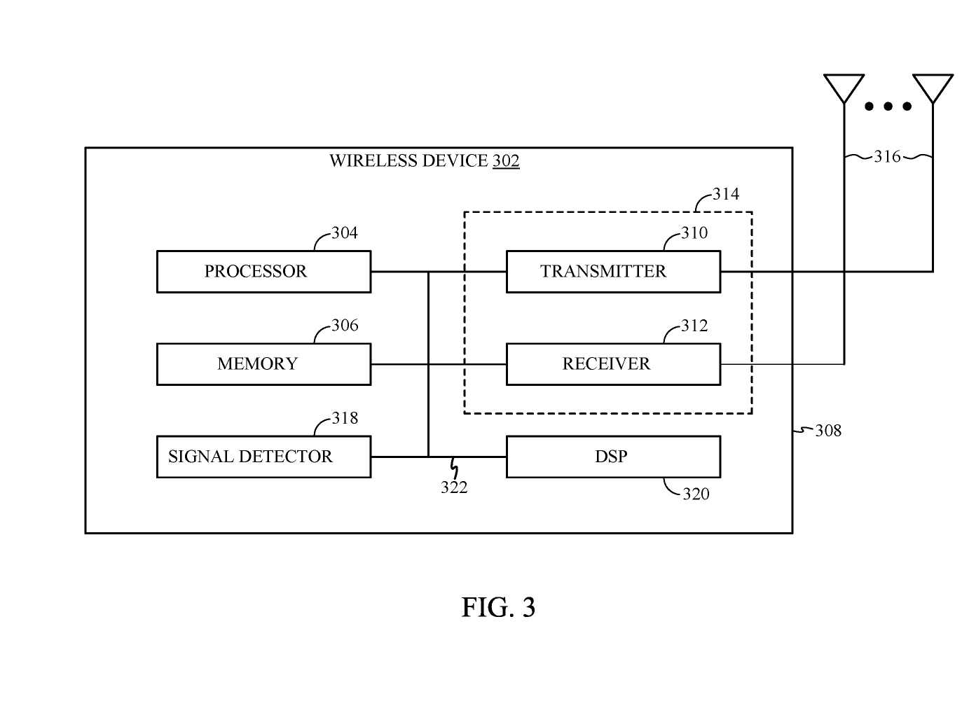

FIG. 3 illustrates various components that may be utilized in a wireless device 302 that may be employed within the MIMO system 100. The wireless device 302 is an example of a device that may be configured to implement the various methods described herein. For example, the wireless device may implement operations 700 and 900 illustrated in FIGS. 7 and 9, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Tone Allocation

As described above, a packet (also referred to as a frame) may be communicated over a wireless medium using a waveform that is modulated over a fixed frequency band during a fixed period of time. The frequency band may be divided into one or more “tones” and the period of time may be divided into one or more “symbols.” As an illustrative non-limiting example, a 20 MHz frequency band may be divided into four 5 MHz tones and an 80 microsecond period may be divided into twenty 4 microsecond symbols. Accordingly, a “tone” may represent a frequency sub-band included in a waveform. A tone may alternately be referred to as a subcarrier. A “tone” may thus be a frequency domain unit. A “symbol” may be a time domain unit representing a duration of time included in the waveform. Thus, the waveform for a wireless packet may thus be visualized as a two-dimensional structure that includes multiple tones (often on a vertical axis in units of frequency) and multiple symbols (on a horizontal axis in units of time).

As an example, a wireless device may receive a packet via a 20 megahertz (MHz) wireless channel (e.g., a channel having 20 MHz bandwidth). The wireless device may perform a 64-point fast Fourier transform (FFT) to determine 64 tones in a waveform of the packet. A subset of the tones may be considered “useable” and the remaining tones may be considered “unusable” (e.g., may be guard tones, direct current (DC) tones, etc.). To illustrate, 56 of the 64 tones may be useable, including 52 data tones and 4 pilot tones. As another example, there may be 48 data tones and 4 pilot tones. It should be noted that the aforementioned channel bandwidths, transforms, and tone plans are for example. According to alternate embodiments, different channel bandwidths (e.g., 5 MHz, 6 MHz, 6.5 MHz, 40 MHz, 80 MHz, etc.), different transforms (e.g., 256-point FFT, 1024-point FFT, etc.), and/or different tone plans may be used.

### Example Short Multi-User Null Data Packet (NDP) Feedback

Aspects of the present disclosure generally provide techniques that may be used for detecting feedback bits from one or more wireless devices based on differences in receive energy on different sets of tones in a resource unit (RU). A RU may span at least a number of tones allocated to a first wireless device for conveying feedback (e.g., spanning available system bandwidth). In some aspects, by using a RU that spans at least a number of tones allocated to a first wireless device for conveying feedback, a wireless device can convey additional bits of feedback relative to a number of bits of feedback that can be transmitted in a narrower bandwidth RU (e.g., a 1 MHz RU having 26 tones). In some aspects, the use of a RU spanning at least a number of tones allocated to a first wireless device for conveying feedback may allow a transmitting device to increase a number of tones used for detecting a bit of feedback to improve feedback reliability by leveraging transmission diversity, as different sets of tones within the RU may experience different channel conditions.

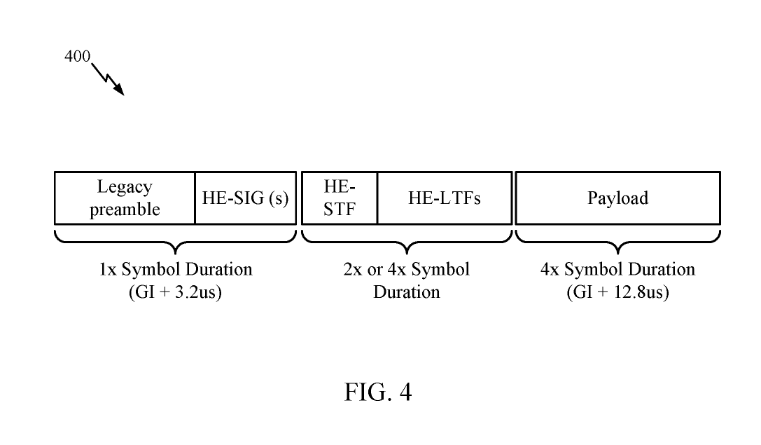

In some applications, longer symbol durations are used for various portions of a frame. For example, FIG. 4 shows an example packet 400, in which a longer symbol duration (e.g., 2× or 4×) is used for HE-LTFs as well as a subsequent data payload. This symbol duration is longer relative to a reference duration (e.g., a 1× symbol duration used for a legacy preamble portion and/or an HE-SIG field.

As longer symbol durations are used in various applications, phase tracking and carrier frequency offset (CFO) adjustments may be necessary due to differences between oscillators at transmitting and receiving devices. The increase in symbol duration for long training fields, such as HE-LTFs may make it desirable to perform phase tracking and/or CFO adjustments during channel estimation, given that HE-LTFs are longer (e.g., 2× or 4× longer) than other symbol durations (e.g., LTFs defined per 802.11ac).

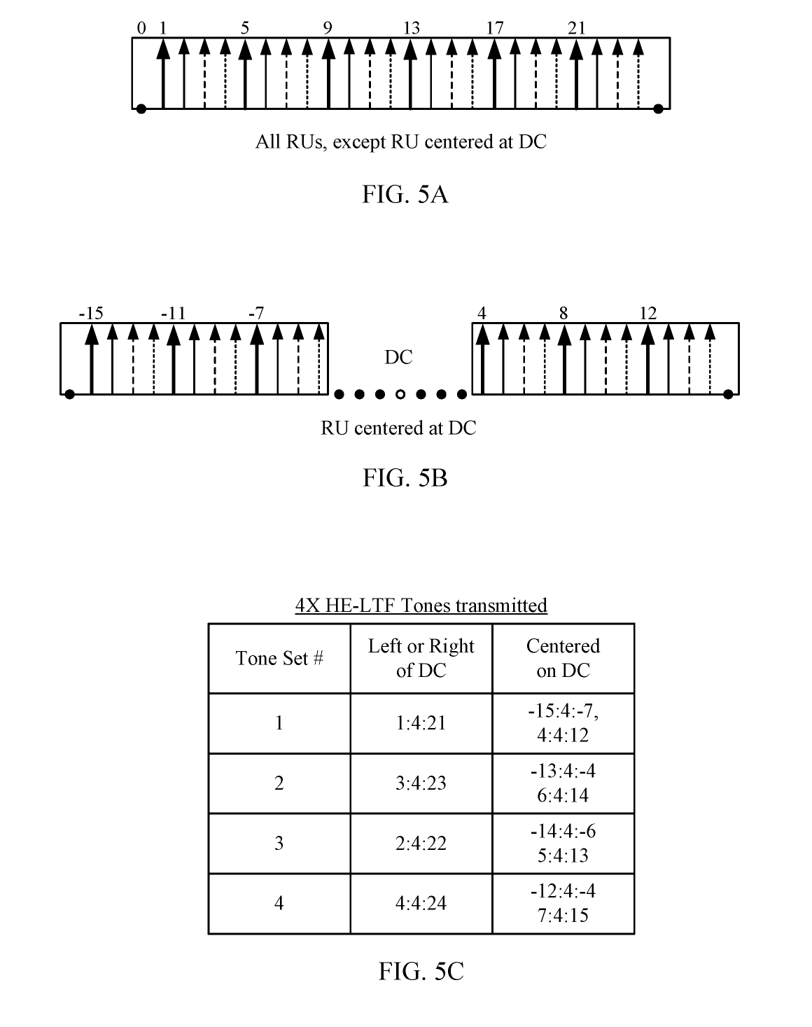

In some cases, a small amount of feedback may be transmitted using null data packets (NDPs). Because NDP packets generally do not include a payload section, the feedback may be conveyed through long training fields, such as an HE-LTF. In some cases, the locations of sets of tones may be used to convey feedback information. For example, as illustrated in FIGS. 5A-5C, using a 26 tone receive unit (RU) (corresponding to 1 MHz of bandwidth) may be divided into four sets of six tones each. Two sets may be allocated to a single user. If the user transmits on the first set of tones but does not transmit on the second set of tones, the receiving device can determine that the user has transmitted a first bit value. If the user transmits on the second set of tones but does not transmit on the first set of tones, the receiving device can determine that the user has transmitted a second bit value.

However, using a narrow bandwidth RU (e.g., 26 tones, 1 MHz in bandwidth) may subject a transmitting device to limitations on power spectral density. For example, regulatory limits may impose limitations on a total power that can be transmitted in a 1 MHz band that are more stringent than a total power that can be transmitted in a wider band. Additionally, using a 26 tone RU, a user can transmit at most two bits of feedback information (a first bit corresponding to the first and second sets of tones, and a second bit corresponding to the third and fourth sets of tones).

To increase an amount of power that can be used for transmitting feedback bits and increase flexibility in transmitting feedback bits (e.g., increasing a number of feedback bits that a station can transmit and/or increasing reliability of feedback bit transmission by allocating different numbers of tones for transmission of feedback bits), feedback may be transmitted on resources spanning at least 106 tones. For example, the resources on which feedback may be transmitted may span 242 tones (e.g., in a 242-tone RU), and the tones for the feedback bits may be spread across the 242-tone RU. The 242 tones may be divided, for example, into 40 sets of six tones each. The 40 sets of tones may represent a maximum of 20 feedback bits, as a value of each bit may be represented by transmit energy on one of two sets of tones. Because the feedback may be transmitted on a wider bandwidth than a 26-tone RU, power spectral density limits may be relaxed, allowing devices to transmit feedback bits using an increased transmit power relative to a maximum transmit power that may be used for transmitting feedback on tones in a narrow bandwidth RU. In some cases, the tones used for transmitting feedback bits may be spread across a PLCP protocol data unit (PPDU) bandwidth.

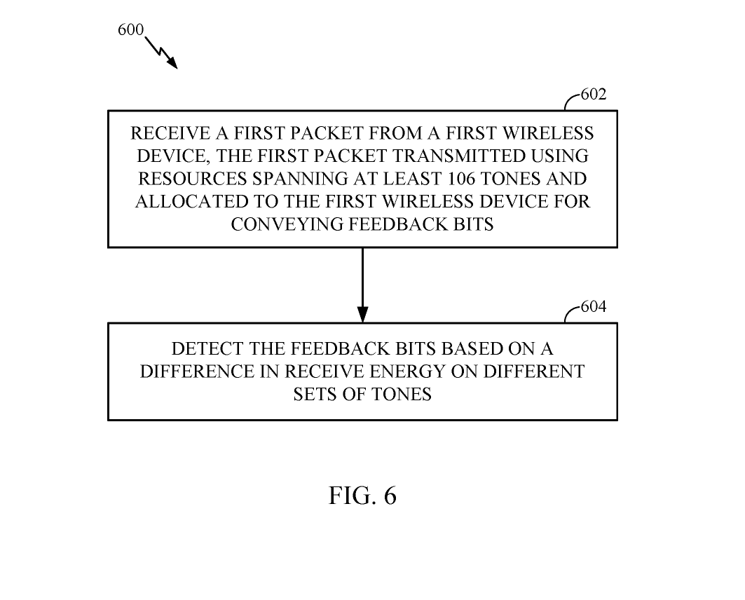

FIG. 6 illustrates example operations that may be performed by a wireless device (e.g., an access point) to detect feedback bits from one or more users based on detecting transmit energy on resources spanning a number of tones (e.g., across at least 106 tones), in accordance with an aspect of the present disclosure. Operations 600 begin at 602, where a device receives a first packet from a first wireless device. The first packet may be transmitted using resources spanning at least 106 tones that are allocated to the first wireless device for conveying feedback bits. As discussed above, the tones may span a channel bandwidth (e.g., a 106-tone RU, a 242-tone RU in a 20 MHz tone plan, or a multiple of 242-tone RUs in a tone plan that is a multiple of 20 MHz (e.g., four 242-tone RUs in an 80 MHz tone plan)). In some cases, the packet may be a null data packet (NDP). At 604, the device detects the feedback bits based on a difference in receive energy on different sets of tones.

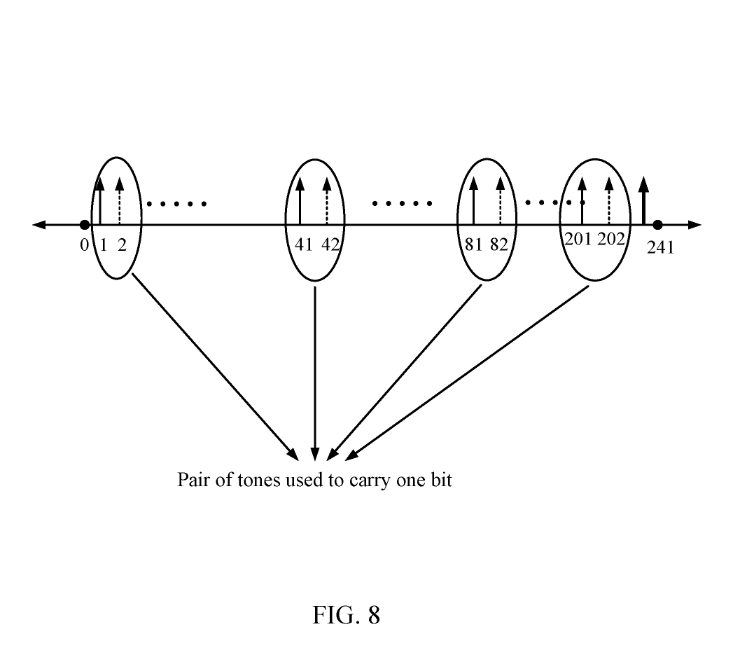

FIG. 7 illustrates example operations that may be performed by a wireless device (e.g., a user terminal) to transmit feedback bits based on differences in transmit energy on resources spanning a number of tones (e.g., across at least 106 tones) to another wireless device (e.g., an access point) in accordance with an aspect of the present disclosure. Operations 700 begin at 702, where a device receives a feedback request from a first wireless device. At 704, the device transmits, to the first wireless device, a first packet. The first packet is generally transmitted using resources spanning at least 106 tones and allocated for conveying feedback bits to the first wireless device. As discussed above, the tones may span a channel bandwidth (e.g., a 106-tone RU, a 242-tone RU in a 20 MHz tone plan, or a multiple of 242-tone RUs in a tone plan that is a multiple of 20 MHz). Values of the feedback bits are generally represented by differences in transmit energy on different sets of tones, as illustrated for example in FIG. 8.

FIG. 8 illustrates an example set of tones that may be used to carry one bit of information. As illustrated, the tone locations of a bit of information may be spread in a coupled manner. For example, in a 242-tone RU, 20 sets of twelve tones may be established. For a single bit of information, a “0” value may be represented by transmitting on a first set of six tones, and a “1” value may be represented by transmitting on a second set of six tones. For example, a first bit of information may be transmitted on tones {1, 2, 41, 42, 81, 82, 121, 122, 161, 162, 201, 202}. A “1” value may be represented by transmitting on tones {1, 41, 81, 121, 161, 201}, while a “0” value may be represented by transmitting on the adjacent tones (e.g., on tones {2, 42, 82, 122, 162, 202}). A second bit of information may be transmitted on tones {3, 4, 43, 44, 83, 84, 123, 124, 163, 164, 203, 204}. A “1” value for the second bit of information may be represented by transmitting on tones {3, 43, 84, 123, 163, 203}, while a “0” value for the second bit of information may be represented by transmissions on tones {4, 44, 84, 124, 164, 204}. In some cases, tone locations for additional bits of information may be derived by induction. Because the tone locations for “0” and “1” values of each feedback bit may be tightly coupled (e.g., be transmitted on tones with a one-tone difference), a receiver may detect nearly the same channel for the different bit values for each feedback bit, which may avoid biases in decision metrics at the receiver. For each of these bit locations, a receiver can determine the value of a bit based on a transmit power difference between the set of tones that represent a “1” value and the set of tones that represent a “0” value.

The use of tone detection in a wideband RU may allow for flexible control of resource allocation and reliability. For example, different user devices may be allocated different numbers of bits for feedback A single user device may be allocated up to 20 bits of feedback (e.g., spanning the entirety of a 242-tone RU). In some cases, multiple users may transmit feedback in an RU. For example, in a 242-tone RU supporting up to 20 bits of feedback, two user devices may each transmit 10 bits of information, four user devices may each transmit 5 bits of information, and so on.

In some cases, user devices may be allocated different numbers of tones, which may improve the reliability of detecting a particular bit of feedback. For example, a user device can be allocated a 12-tone set to transmit a bit of feedback, which may entail transmitting on six tones to indicate a “0” or “1” value of a feedback bit. If a user device is allocated a 24-tone set, the user device can transmit on 12 tones to indicate a “0” or “1” value of a feedback bit.

In some cases, feedback may be received on multiple spatial streams. Increasing a number of spatial streams on which feedback is received may increase a data carrying capability for feedback from user devices. For example, 20 bits of feedback may be received using a single spatial stream, 40 bits of feedback may be received using two spatial streams, and so on.

In some cases, feedback may be received on a wider system bandwidth than that covered by a 242-tone RU. In some cases, the allocation of tones in a 242-tone RU may be duplicated within each 242-tone RU in a wider system bandwidth. In some cases, a user may transmit feedback within a single 242-tone RU (e.g., in a 20 MHz system bandwidth). The tone transmission indices discussed above may be, in some cases, duplicated for each 242-tone RU in a wider tone plan (e.g., in each of the four 242-tone RUs in an 80 MHz system bandwidth).

In some cases, a UE can detect feedback based on a differential scheme on pairs of tones used to transmit feedback to a UE. A non-zero symbol (e.g., a symbol with a value of “1” or “−1”) may be carried on each tone. To determine the value of a feedback bit transmitted to the UE, the UE can identify a first set of tones (e.g., odd-numbered tones) and a second set of tones (e.g., even-numbered tones) and obtain a value for each tone in the respective sets. The UE can subsequently correlate the values of the first set of tones and the second set of tones (e.g., by obtaining a dot product of the first and second sets) to identify the value of a feedback bit transmitted to the UE. In some cases, a UE can identify the value of the feedback bit based on a sign of the dot product of the first and second sets of tones. For example, a negative dot-product may correspond to a feedback bit value of 1, while a positive dot-product may correspond to a feedback bit value of 0.

FIG. 9 illustrates example operations that may be performed by a wireless device to detect feedback bits from one or more users based on a differential scheme, in accordance with an aspect of the present disclosure. As illustrated, operations 900 begin at 902, where a device receives a first packet from a first wireless device. The first packet may be transmitted using resources spanning at least 106 tones that are allocated to the first wireless device for conveying feedback bits. As discussed above, the tones may span a channel bandwidth (e.g., a 106-tone RU, a 242-tone RU in a 20 MHz tone plan, or a multiple of 242-tone RUs in a tone plan that is a multiple of 20 MHz (e.g., four 242-tone RUs in an 80 MHz tone plan)). In some cases, the packet may be a null data packet (NDP). At 904, the device detects the feedback bits based on values received from the first wireless device on different sets of tones.

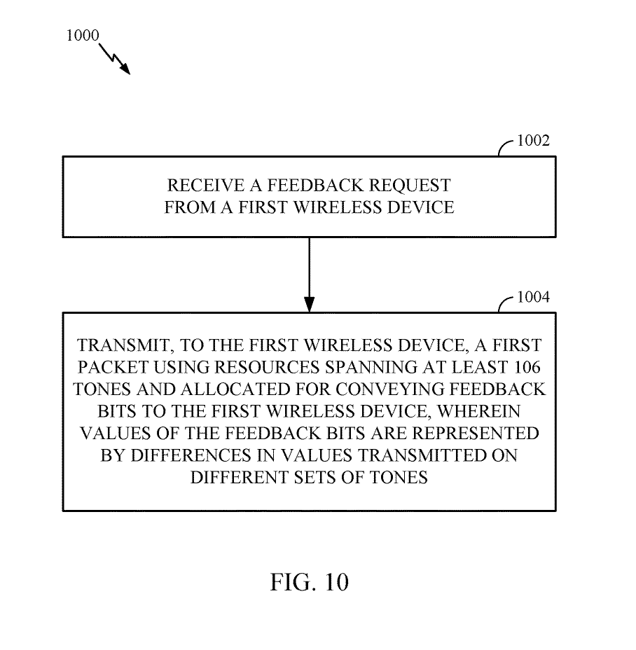

FIG. 10 illustrates example operations that may be performed by a wireless device to transmit feedback bits based on a differential scheme, in accordance with an aspect of the present disclosure. As illustrated, operations 1000 begin at 1002, where a device receives a feedback request from a first wireless device. At 1004, the device transmits a first packet to the first wireless device. The first packet may be transmitted using resources spanning at least 106 tones that are allocated to the first wireless device for conveying feedback bits. As discussed above, the tones may span a channel bandwidth (e.g., a 106-tone RU, a 242-tone RU in a 20 MHz tone plan, or a multiple of 242-tone RUs in a tone plan that is a multiple of 20 MHz). The value of the feedback bits transmitted is generally represented by differences in values transmitted on different sets of tones. For example, as discussed above, a negative dot-product of a first and second set of tones may correspond to a feedback bit value of 1, while a positive dot-product of the first and second set of tones may correspond to a feedback bit value of 0.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for receiving and means for obtaining may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting and means for outputting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for detecting may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for determining a period that at least one second apparatus is scheduled to be awake, instructions for generating a first frame for transmission to the second apparatus during the period, instructions for outputting the first frame for transmission, instructions for obtaining a second frame in response to the first frame, instructions for determining ranging information based on a time difference between transmission of the first frame and receipt of the second frame, instructions for generate a third frame including the ranging information, and instructions for outputting the third frame for transmission. In another example, instructions for determining a period to awake from a low power state, instructions for obtaining a first frame from a second apparatus during the period, instructions for generating a second frame for transmission to the second apparatus in response to the first frame, instructions for outputting the second frame for transmission to the second apparatus, instructions for obtaining a third frame comprising ranging information, determined by the second apparatus, based on a time difference between transmission of the first frame and receipt of the second frame, and instructions for determining a relative location of the second apparatus to the first apparatus based on a third frame.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
receiving a first packet from a first wireless device, the first packet transmitted using resources spanning at least 106 tones and allocated to the first wireless device for conveying feedback bits; and
detecting the feedback bits based on a difference in receive energy on different sets of tones.

2. The method of claim 1, wherein the feedback bits comprise at least two bits of information.

3. The method of claim 1, wherein the resources are spread across a 242 tone resource unit (RU).

4. The method of claim 1, wherein the resources are spread across a physical layer convergence protocol (PLCP) protocol data unit (PPDU) bandwidth.

5. The method of claim 1, wherein the detection comprises:
detecting a first value of a first feedback bit if a difference in receive energy between a first set of tones and a second set of tones is above a first threshold value, or
detecting a second value of the first feedback bit if a difference in receive energy between the second set of tones and the first set of tones is above the first threshold value.

6. The method of claim 1, wherein tones in each of the different sets are evenly spaced.

7. The method of claim 6, wherein tones in a first set and a second set of the different sets of tones are adjacent to each other.

8. The method of claim 1, further comprising:
receiving a second packet from a second wireless device, the second packet transmitted on a second set of tones spanning the at least 106 tones and allocated to the second wireless device for conveying one or more feedback bits, wherein the tones allocated to the second wireless device are different than the tones allocated to the first wireless device; and
detecting the one or more feedback bits based on a difference in receive energy on the tones allocated to the second wireless device

9. The method of claim 1, wherein the first packet comprises a null data packet (NDP).

10. A method for wireless communications, comprising:
receiving, from a first wireless device, a feedback request; and
transmitting a first packet to the first wireless device using resources spanning at least 106 tones and allocated for conveying feedback bits to the first wireless device, wherein values of the feedback bits are based on differences in transmit energy on different sets of tones.

11. The method of claim 10, wherein the feedback bits comprise at least two bits of information.

12. The method of claim 10, wherein the resources are spread across a 242 tone resource unit (RU).

13. The method of claim 10, wherein the resources are spread across a physical layer convergence protocol (PLCP) protocol data unit (PPDU) bandwidth.

14. The method of claim 10, wherein a value of a first feedback bit of the feedback bits comprises:
a first value, if a difference in transmit energy between a first set of tones and a second set of tones is above a first threshold value; or
a second value, if a difference in transmit energy between the second set of tones and the first set of tones is above the first threshold value.

15. The method of claim 10, wherein tones in each of the different sets are evenly spaced.

16. The method of claim 15, wherein tones in a first set and a second set of the different sets of tones are adjacent to each other.

17. The method of claim 1, wherein the first packet comprises a null data packet (NDP).

18. A system, comprising:
a memory; and
a processor configured to:
receive a first packet from a first wireless device, the first packet transmitted using resources spanning at least 106 tones and allocated to the first wireless device for conveying feedback bits; and
detect the feedback bits based on a difference in receive energy on different sets of tones.

19. The system of claim 18, wherein the resources are spread across a 242 tone resource unit (RU).

20. The system of claim 18, wherein the resources are spread across a physical layer convergence protocol (PLCP) protocol data unit (PPDU) bandwidth.

21. The system of claim 18, wherein the detection comprises:
detecting a first value of a first feedback bit if a difference in receive energy between a first set of tones and a second set of tones is above a first threshold value, or
detecting a second value of the first feedback bit if a difference in receive energy between the second set of tones and the first set of tones is above the first threshold value.

22. The system of claim 18, wherein tones in each of the different sets are evenly spaced.

23. The system of claim 22, wherein tones in a first set and a second set of the different sets of tones are adjacent to each other.

24. The system of claim 18, further comprising:
receiving a second packet from a second wireless device, the second packet transmitted on a second set of tones spanning the at least 106 tones and allocated to the second wireless device for conveying one or more feedback bits, wherein the tones allocated to the second wireless device are different than the tones allocated to the first wireless device; and
detecting the one or more feedback bits based on a difference in receive energy on the tones allocated to the second wireless device

25. The system of claim 18, wherein the first packet comprises a null data packet (NDP).

26. A system, comprising:
a memory; and
a processor configured to:
receive, from a first wireless device, a feedback request; and
transmit a first packet to the first wireless device using resources spanning at least 106 tones and allocated for conveying feedback bits to the first wireless device, wherein values of the feedback bits are based on differences in transmit energy on different sets of tones.

27. The system of claim 26, wherein the resources are spread across a 242 tone resource unit (RU).

28. The system of claim 26, wherein the resources are spread across a physical layer convergence protocol (PLCP) protocol data unit (PPDU) bandwidth.

29. The system of claim 26, wherein a value of a first feedback bit of the feedback bits comprises:
a first value, if a difference in transmit energy between a first set of tones and a second set of tones is above a first threshold value; or
a second value, if a difference in transmit energy between the second set of tones and the first set of tones is above the first threshold value.

30. The system of claim 26, wherein tones in each of the different sets are evenly spaced, and wherein tones in a first set and a second set of the different sets of tones are adjacent to each other.
